(19) United States
(12) Patent Application Publication
(10) Pub. No.: US 2018/0039854 A1
(43) Pub. Date: Feb. 8, 2018

(54) PERSONALIZED IMAGE COLLECTIONS

(71) Applicant: Google Inc., Mountain View, CA (US)

(72) Inventor: Christopher WREN, Arlington, MA (US)

(73) Assignee: Google Inc., Mountain View, CA (US)

(21) Appl. No.: 15/226,483

(22) Filed: Aug. 2, 2016

(51) Int. Cl. G06K 9/46; G06F 3/0484; G06T 1/00

(52) U.S. Cl. CPC G06K 9/4671; G06T 1/0007; G06F 3/04845; G06F 3/04842; G06T 2200/24

(57) ABSTRACT

A computer-implemented method includes generating a metric for a first user that reflects preferences for image attributes, determining image attributes for a first set of images associated with a second user, selecting a subset of the first set of images for the first user based on the metric and the image attributes for the first set of images, and providing the subset of the first set of images to the first user.

### BACKGROUND

A first user may be associated with a user account, e.g., provided by an online service provider, that includes many images that are electronically available. A second user may have liked some of the photos (e.g., by providing a +1, like, thumbs up, etc.) and/or comments. Particularly when the first user has hundreds or even thousands of images associated with the first user's account, it may be time consuming for the second user to determine which of those images the second user liked. The second user many manually view the images, but depending on the number of images associated with the first user's account, this may take a substantial amount of time, e.g., several hours or possibly several days.

Similarly, the second user may want to view new images associated with the first user, but the second user may not want to wade through hundreds or thousands of images to find the images that are of interest to the second user. For example, if the first user uploads a photo album of 200 images from the first user's trip to Greece, the second user may not spend the time to look through the album to find the images in the album that the second user would enjoy viewing.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations generally relate to a computer-implemented method to generate a personalized image collection. The method includes generating a metric for a first user that reflects preferences for image attributes. The method includes determining image attributes for a first set of images associated with a second user. The method includes selecting a subset of the first set of images for the first user based on the metric and the image attributes for the first set of images. The method includes providing the subset of the first set of images to the first user.

In some implementations, selecting the subset of the first set of images is based on an identification of images of the first set of images where the first user provided at least one of an indication of approval and a comment. In some implementations, generating the metric comprises: identifying a second set of images for which the user provided a comment on each image in the second set of images, performing sentiment analysis on a respective comment associated with each image, wherein the respective comment includes at least one of a positive reaction, a neutral reaction, and a negative reaction, and determining, based on the sentiment analysis, image attributes for each image of the second set of images. In some implementations, generating the metric comprises: identifying a second set of images that the first user provided, determining image attributes associated with the second set of images, and determining the preferences for the image attributes associated with the second set of images as being positive to the first user based on the first user providing the second set of images. In some implementations, determining image attributes associated with the second set of images includes at least one of performing object recognition to identify one or more objects in the second set of images, performing optical character recognition to identify text in the second set of images, performing object recognition to identify one or more people in the second set of images; and performing style recognition to identify one or more styles in the second set of images. In some implementations, wherein selecting the subset of the first set of images for the first user based on the metric and the image attributes for the first set of images includes: for each image of the first set of images, computing a metric score based on the metric and the image attributes, comparing each metric score to a threshold score value, and selecting the subset to include images from the first set of images with corresponding metric scores that meet the threshold score value. In some implementations, the method further comprises providing the first user with an option to causes a backdrop to be generated from a subset of images, a photo book to be generated, or the subset of images to be aggregated to form a collage. In some implementations, the method further comprises providing the second user with the subset of the first set of images, wherein a first image of the subset of the first set of images includes a link that, when selected, causes a display of a comment associated with the first image. In some implementations, generating the metric for the first user that includes preferences for image attributes comprises: providing to the first user a first image and a second image with a request to select a preferred image from the first image and the second image, receiving a selection of the first image from the first user, and identifying the image attributes associated with the first image that are not associated with the second image.

In some implementations, a non-transitory computer storage medium encoded with a computer program, the computer program comprising instructions that, when executed by one or more processors, cause the one or more processors to perform operations comprising: generating a metric for a first person that reflects preferences for image attributes, determining image attributes for a first set of images associated with a second user, selecting a subset of the first set of images for the second user based on the metric and the image attributes for the first set of images, and providing the subset of the first set of images to the second user.

In some implementations, the method includes means for generating a metric for a first user that reflects preferences for image attributes, means for determining image attributes for a first set of images associated with a second user, means for selecting a subset of the first set of images for the first user based on the metric and the image attributes for the first set of images, and means for providing the subset of the first set of images to the first user.

Other aspects may include corresponding methods, systems, apparatus, and computer program products.

The system and methods described below advantageously solves the problem where a user is overwhelmed by a number of images. The systems and methods select a subset of images that are personalized for a person. The person may be a user that is looking at another user's images or the person may be, for example, a famous photographer and the subset of images may be selected based on what the famous photographer might prefer.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 illustrates a block diagram of an example system that generates personalized image collections according to some implementations.

FIG. 2 illustrates a block diagram of an example computing device that generates personalized image collections according to some implementations.

FIG. 3 illustrates a graphic representation of an example option to personalize another user's images according to some implementations.

FIG. 4 illustrates a graphic representation of an example option to personalize a user's images according to some implementations.

FIG. 5 illustrates a flowchart of an example method to generate personalized images according to some implementations.

### DETAILED DESCRIPTION

A first user may prefer to see a subset of images associated with a second user based on personalizing the images for the first user. The first user may have already viewed the subset of images. For example, the subset of images may be selected based on the first user previously providing an indication of approval and/or a comment. In some implementations, the first user may not have previously viewed the subset of images. Instead, the subset of images may be selected based on determining what image attributes the first user would like to see. For example, the first user may be the second user's father and the first user may prefer to see images that include the second user's kids, i.e., the first user's grandchildren. The subset of images may be aggregated into a photo book or a collage or combined to form a backdrop that displays the images in a series. For example, the first user may be a grandmother that would enjoy receiving a photo book with the subset of images.

In some implementations, a user may want to have their images personalized based on another person's aesthetics. For example, a first person may be a celebrity and a first user may want to view a subset of their images based on the type of images that the celebrity might like. In another example, the person may be a famous photographer who captures black and white images, and the first user may be an amateur photographer that is looking to emulate the style of the photographer. In some implementations, selecting a subset of images based on a metric may further include providing an automated critique of the images based on the metric. In this example, the critique could include comments about the placement of subjects in the images, comments about images that are blurry, comments about images that include too much empty space, etc.

### Example System

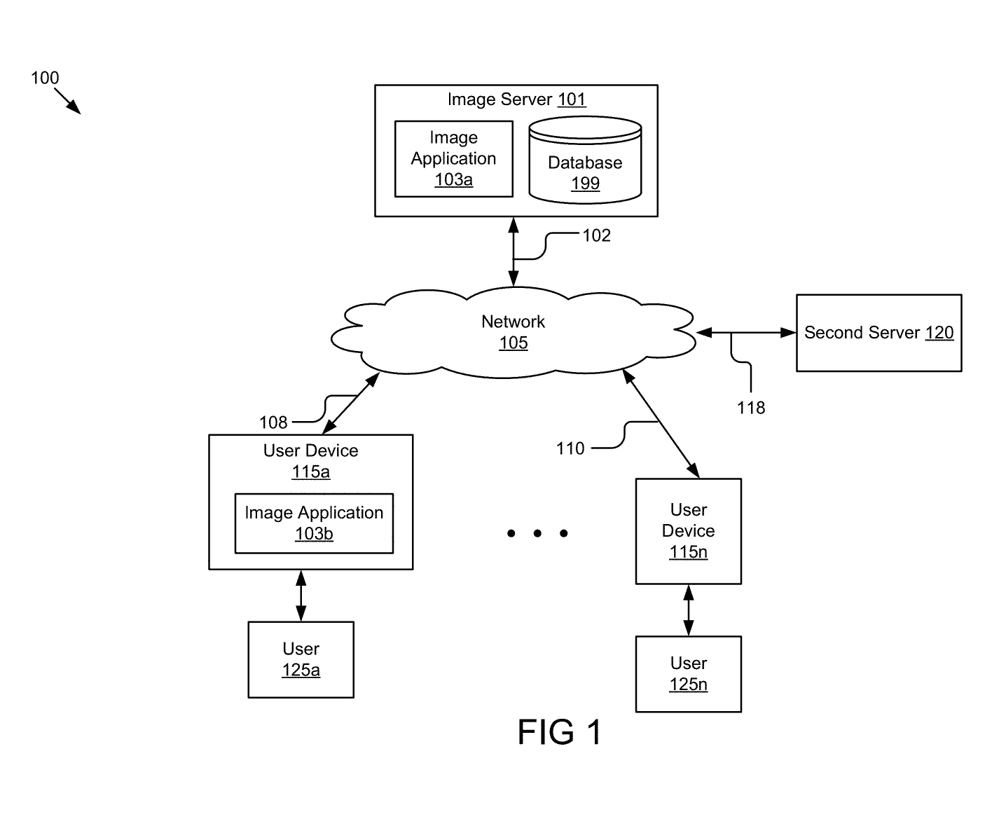

FIG. 1 illustrates a block diagram of an example system 100 that generates personalized image collections according to some implementations. The illustrated system 100 includes an image server 101, user devices 115a, 115n, a second server 120, and a network 105. Users 125a, 125n may be associated with respective user devices 115a, 115n. In some implementations, the system 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to implementations of the element bearing that reference number.

In the illustrated implementation, the entities of the system 100 are communicatively coupled via the network 105. The network 105 may be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some implementations, the network 105 may be a peer-to-peer network. The network 105 may also be coupled to or include portions of a telecommunications network for sending data in a variety of different communication protocols. In some implementations, the network 105 includes Bluetooth® communication networks, WiFi®, or a cellular communications network for sending and receiving data including via short messaging service (SMS), multimedia messaging service (MMS), hypertext transfer protocol (HTTP), direct data connection, email, etc. Although FIG. 1 illustrates one network 105 coupled to the user devices 115 and the image server 101, in practice one or more networks 105 may be coupled to these entities.

The image server 101 may include a processor, a memory, and network communication capabilities. In some implementations, the image server 101 is a hardware server. The image server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some implementations, the image server 101 sends and receives data to and from one or more of the user devices 115a, 115n and the second server 120 via the network 105. The image server 101 may include an image application 103a and a database 199.

The image application 103a may be code and routines operable to generate personalized image collections. In some implementations, the image application 103a may be implemented using hardware including a field-programmable gate array (FPGA) or an application-specific integrated circuit (ASIC). In some implementations, the image application 103a may be implemented using a combination of hardware and software.

The database 199 may store images associated with, e.g., created or uploaded by users 125 associated with user devices 115 and image collections generated from the images. In some implementations, the database 199 may store images that were generated independent of the user devices 115. The database 199 may also store social network data associated with users 125, information received from the second server 120, user preferences for the users 125, etc.

The user device 115 may be a computing device that includes a memory and a hardware processor, for example, a camera, a laptop computer, a desktop computer, a tablet computer, a mobile telephone, a wearable device, a head-mounted display, a mobile email device, a portable game player, a portable music player, a reader device, a television with one or more processors embedded therein or coupled thereto, or other electronic device capable of accessing a network 105.

In the illustrated implementation, user device 115a is coupled to the network 105 via signal line 108 and user device 115n is coupled to the network 105 via signal line 110. Signal lines 108 and 110 may be a wired connection, such as Ethernet, coaxial cable, fiber-optic cable, etc., or a wireless connection, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

In some implementations, the user device 115 can be a mobile device that is included in a wearable device worn by the user 125. For example, the user device 115 is included as part of a clip (e.g., a wristband), part of jewelry, or part of a pair of glasses. In another example, the user device 115 can be a smart watch. The user 125 may view images from the image application 103 on a display of the device worn by the user 125. For example, the user 125 may view the images on a display of a smart watch or a smart wristband.

In some implementations, image application 103b may be stored on a user device 115a. The image application 103 may include a thin-client image application 103b stored on the user device 115a and an image application 103a that is stored on the image server 101. For example, the image application 103a stored on the image server 101 may generate a personalized image collection that is transmitted for display to the image application 103b stored on the user device 115a. In another example, the image application 103b stored on the user device 115a may generate the personalized image collection and transmit the personalized image collection to the image application 103a stored on the image server 101. The image application 103a stored on the image server 101 may include the same components or different components as the image application 103b stored on the user device 115a.

In some implementations, the image application 103 may be a standalone application stored on the image server 101 or the user device 115. A user 125a may access the image application 103 via a web pages using a browser or via other software on the user device 115a. For example, the user 125a may upload images stored on the user device 115a or from another source, such as from the second server 120, to the image application 103, which generates a personalized image collection.

The second server 120 may include a processor, a memory, and network communication capabilities. In some implementations, the second server 120 is a hardware server. The second server 120 is communicatively coupled to the network 105 via signal line 118. Signal line 118 may be a wired connection, such as Ethernet, coaxial cable, fiber-optic cable, etc., or a wireless connection, such as Wi-Fi®, Bluetooth®, or other wireless technology. In some implementations, the second server 120 sends and receives data to and from one or more of the image server 101 and the user devices 115a-115n via the network 105.

The second server 120 may provide data to the image application 103. For example, the second server 120 may be a separate server that provides images that are used by the image application 103 to generate personalized image collections. The second server 120 may host a social network, a photo sharing website, a messaging application, a chat service, or a media sharing website where a personalized image collection may be shared by a user 125 with other users of the service provided by the second server 120. The second server 120 may store comments, approvals, disapprovals, etc. for the images via the social network. In yet another example, the second server 120 may include image processing software that, upon user consent, analyzes images to identify objects, faces, events, a type of photography style, text, etc. The second server 120 may be associated with the same company that maintains the image server 101 or a different company.

As long as a user consents to the use of such data, the second server 120 may provide the image application 103 with profile information or profile images of a user that the image application 103 may use to identify a person in an image with a corresponding social network profile. In another example, the second server 120 may provide the image application 103 with information related to entities identified in the images used by the image application 103. For example, the second server 120 may include an electronic encyclopedia that provides information about landmarks identified in the images, an electronic shopping website that provides information for purchasing entities identified in the images, an electronic calendar application that provides, subject to user consent, an event name associated with an image, a map application that provides information about a location associated with a video, etc.

In situations in which the systems and methods discussed herein may collect or use personal information about users (e.g., user data, information about a user's social network, user's preferences, user's activities, and user's demographic information), users are provided with opportunities to control whether information is collected, whether the personal information is stored, whether the personal information is used, whether the videos are analyzed, and how the information about the user is collected, stored, and used. That is, the systems and methods discussed herein collect, store, and/or use user personal information only upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity information may be treated, e.g., anonymized, so that no personally identifiable information can be determined from an image. As another example, a user's geographic location may be generalized to a larger region so that the user's particular location cannot be determined.

### Example Computing Device

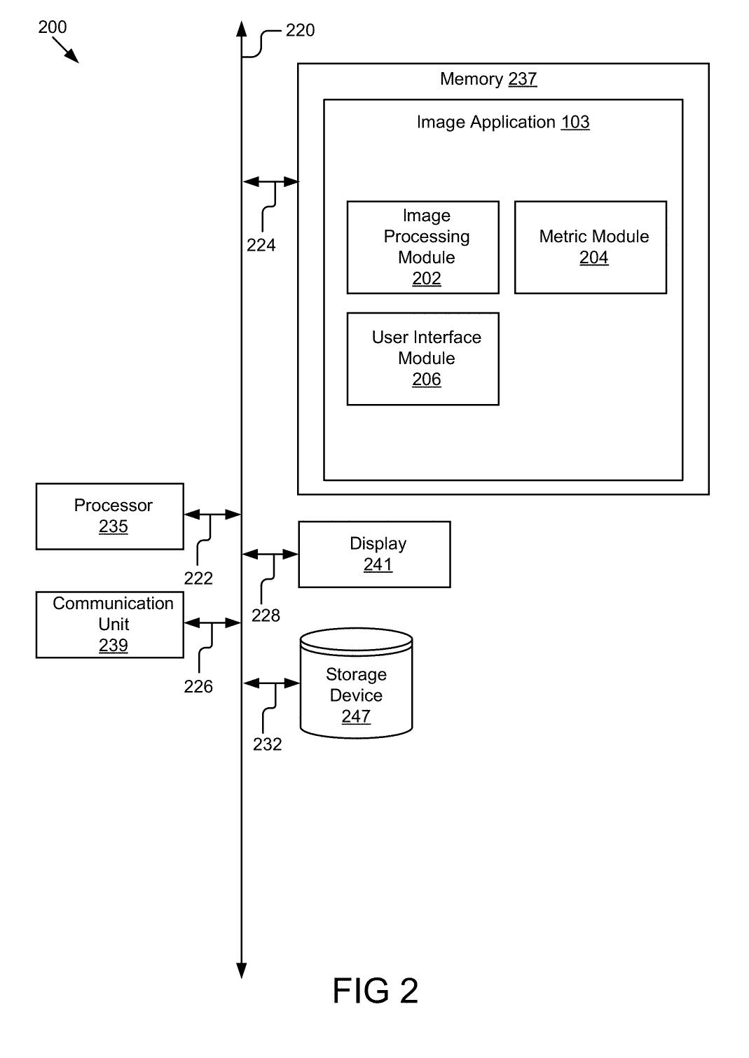

FIG. 2 illustrates a block diagram of an example computing device 200 that generates personalized image collections. The computing device 200 may be an image server 101 or a user device 115. The computing device 200 may include a processor 235, a memory 237, a communication unit 239, a display 241, and a storage device 247. An image application 103 may be stored in the memory 237. The components of the computing device 200 may be communicatively coupled by a bus 220.

The processor 235 includes an arithmetic logic unit, a microprocessor, a general purpose controller or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 includes a single processor 235, multiple processors 235 may be included, e.g., one or more multicore processors where multiple processing cores are provided in a single package, a multiprocessor where multiple processors are provided separately, etc. Processor 235 may also include special purpose processing units, such as graphics processing units (GPUs), hardware accelerators, etc. Other processors, operating systems, sensors, displays and physical configurations may be part of the computing device 200. The processor 235 is coupled to the bus 220 for communication with the other components via signal line 222.

The memory 237 stores instructions that may be executed by the processor 235 and/or data. The instructions may include code for performing the techniques described herein. The memory 237 may be a dynamic random access memory (DRAM) device, a static RAM, or some other memory device. In some implementations, the memory 237 also includes a non-volatile memory, such as a (SRAM) device or flash memory, or similar permanent storage device and media including a hard disk drive, a floppy disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the image application 103, which is described in greater detail below. The memory 237 is coupled to the bus 220 for communication with the other components via signal line 224.

The communication unit 239 transmits and receives data to and from at least one of the user device 115, the image server 101, and the second server 120 depending upon where the image application 103 may be stored. In some implementations, the communication unit 239 includes a port for direct physical connection to the network 105 or to another communication channel. For example, the communication unit 239 includes a universal serial bus (USB), secure digital (SD), category 5 cable (CAT-5) or other port for wired communication with the user device 115 or the image server 101, depending on where the image application 103 may be stored. In some implementations, the communication unit 239 includes a wireless transceiver for exchanging data with the user device 115, image server 101, or other communication channels using one or more wireless communication methods, including IEEE 802.11, IEEE 802.16, Bluetooth® or another suitable wireless communication method. The communication unit 239 is coupled to the bus 220 for communication with the other components via signal line 226.

In some implementations, the communication unit 239 includes a cellular communications transceiver for sending and receiving data over a cellular communications network including via short messaging service (SMS), multimedia messaging service (MMS), hypertext transfer protocol (HTTP), direct data connection, e-mail or another suitable type of electronic communication. In some implementations, the communication unit 239 includes a wired port and a wireless transceiver. The communication unit 239 also provides other conventional connections to the network 105 for distribution of files and/or media objects using standard network protocols including, but not limited to, user datagram protocol (UDP), TCP/IP, HTTP, HTTP secure (HTTPS), simple mail transfer protocol (SMTP), SPDY, quick UDP internet connections (QUIC), etc.

The display 241 may include hardware operable to display graphical data received from the image application 103. For example, the display 241 may render graphics to display a personalized image collection. The display 241 is coupled to the bus 220 for communication with the other components via signal line 228. Other hardware components that provide information to a user may be included as part of the computing device 200. In some implementations, such as where the computing device 200 is an image server 101, the display 241 may be optional. In some implementations, the computing device 200 may not include all the components. In implementations where the computing device 200 is a wearable device, the computing device 200 may not include storage device 247. In some implementations, the computing device 200 may include other components not listed here, such as one or more cameras, sensors, a battery, etc.

The storage device 247 may be a non-transitory computer-readable storage medium that stores data that provides the functionality described herein. In implementations where the computing device 200 is the image server 101, the storage device 247 may include the database 199 in FIG. 1 and the image application 103. The storage device 247 may be a DRAM device, a SRAM device, flash memory or some other memory device. In some implementations, the storage device 247 also includes a non-volatile memory or similar permanent storage device and media including a hard disk drive, a memory card, a CD-ROM device, a DVD-ROM device, a DVD-RAM device, a DVD-RW device, a flash memory device, or some other mass storage device for storing information on a permanent basis. The storage device 247 is coupled to the bus 220 for communication with the other components via signal line 232.

In the illustrated implementation shown in FIG. 2, the image application 103 includes an image processing module 202, a metric module 204, and a user interface module 206. Other modules and/or configurations are possible.

The image processing module 202 may be operable to determine attributes associated with images and user reactions to the images. In some implementations, the image processing module 202 may include a set of instructions executable by the processor 235 to determine attributes associated with images and user reactions to the images. In some implementations, the image processing module 202 may be stored in the memory 237 of the computing device 200 and can be accessible and executable by the processor 235.

The image processing module 202 may determine image attributes that include identifying image metadata, identifying an image as black and white, identifying a percentage of different colors in an image (e.g., based on a histogram), identifying subject matter (e.g., a beach, a mountain, people, etc.), a composition style (portrait, landscape, panorama, low light, filtered, etc.), location, and image resolution (e.g., high resolution, low resolution, etc.).

The image processing module 202 may determine image attributes based on metadata associated with the images. For example, the image processing module 202 may determine, based on the metadata, a time and a date of capture, a location of capture, camera type, ISO, an aperture setting, etc. The image processing module 202 may use the metadata to help identify attributes in the images. For example, the image processing module 202 may determine based on the metadata indicating a time, a date, and a location of capture that an image was captured at a musical event held in the desert. As a result, the image processing module 202 may associated an image with a particular style of photography employed by people who take images at a musical event in the desert.

The image processing module 202 may determine qualities associated with images by performing object recognition to identify objects in the images; upon user consent, performing object recognition to identify people in the images; and performing style recognition to identify styles in the images.

The image processing module 202 may perform object recognition to identify objects, such as a dog, a house, a car, etc. The image processing module 202 may use the metadata in conjunction with object recognition to identify landmarks. For example, the image processing module 202 may use location information to identify that an image is of trees in a national forest. For example, the image processing module may determine that the image is of a giant sequoia in Sequoia National Park, based on the object recognition and the location information. The image processing module 202 may perform optical character recognition (OCR) to identify text in the image. The image processing module 202 may identify an image attribute based on the text. For example, the image processing module 202 may recognize text from an image such as “General Sherman's Tree” based on OCR and identify the image attribute as “General Sherman's Tree.”

Upon user consent, the image processing module 202 may perform object recognition to identify people in the images. In some implementations, the object rejection may include facial recognition to identify one or more people based on facial attributes of the one or more people in the image. The image processing module 202 may compare an image of a face to images of people, compare the image to other members that use the image application 103, etc. In some implementations, upon user consent, the image processing module 202 may request identifying information from the second server 120. For example, the second server 120 may maintain a social network and the image processing module 202 may request profile images or other images of social network users that are connected to the user associated with the image.

The image processing module 202 may perform style recognition to identify styles in the images. For example, the image processing module 202 may identify that an image was captured in black and white and, as a result, the image was captured with a black and white style. For example, other photography styles may include color photography, stock photography, wedding photography, flash photography, photojournalism, panorama photography, pictorialism, and vernacular photography. In some implementations, the image processing module 202 may determine a style associated with an image based on a filter applied to the image. The filter may be a physical filter added to a lens, e.g., at the time of image capture, or a software filter applied during post-processing of the image. For example, the filter may include sepia, skylight, round, square, clarendon, gingham, moon, lark, reyes, juno, slumber, crema, ledwig, aden, perpetua, amaro, etc.

In some implementations, the image processing module 202 may identify image attributes that relate to quality of an image. The quality may be subjective and based on a user's reaction to images. For example, the image processing module 202 may determine whether the user prefers images that are in focus or images that are blurry (e.g., because they are more artistic). In some implementations, the image processing module 202 may include default image attributes that presume that the user prefers image attributes that are commonly associated with high-quality images unless user reactions alter the presumption. For example, the default image attributes may include images that are in focus, with a particular color balance (e.g., not overexposed), with subjects that are placed in the center of the image (e.g., as opposed to off to the side or at a corner or with part of the subject's face cut off), etc.

The image processing module 202 may identify images associated with a user and determine the user's reaction to the images. The images may be associated with a user when the user captured the images (e.g., the images are stored on a user device associated with a user), the user shared the images, or the user interacted with the images in another way (e.g., the user provided an indication of approval of an image, the user commented on an image, etc.).

In some implementations, the image processing module 202 receives an image with a corresponding user reaction. The image and the user reaction may be received from an application generated by the image application 103 or an application hosted by the second server 120, such as an online photo sharing website, an email application, a chat application etc. Responsive to the user providing content to use of the data, the image processing module 202 may determine the user's reaction to images by identifying indications of approval (+1, like, thumbs up, etc.), indications of disapproval (−1, dislike, thumbs down, etc.), reactions based on comments, implicit signals from the user, and approvals in response to a comparison of images (e.g., when the user interface module 206 asks a user to select one image from two or more images).

Responsive to the user providing content to use of the data, the image processing module 202 may determine user reactions to images that the user viewed based on comments by performing sentiment analysis. For example, the image processing module 202 may associate emojis provided by the user in a comment associated with an image with positive or negative reactions, such as [symbol] being associated with a positive reaction and [symbol] being associated with a negative reaction. In another example, the image processing module 202 may associate words in the comments with positive or negative reactions, such as “Great!” being associated with a positive reaction and “Gross!” being associated with a negative reaction.

Responsive to the user providing content to use of the data, the image processing module 202 may determine implicit signals from the user based on the user's behavior with regard to the images. For example, the image processing module 202 may determine that the user has a positive reaction to an image if the user provides an image (e.g., by uploading the image to the image application 103, saves the image to a collection associated with the user, shares the image with another user, etc.). In another example, the image processing module 202 may determine that the user has a positive reaction to an image if the user views the image for longer than a predetermined threshold value of time. For example, the predetermined threshold value of time may be an average amount of time that the user, or other users spend viewing an image. In another example, the predetermined threshold value of time may be determined for an image, e.g., based on an aggregate amount of time that prior viewers spent viewing the image. Alternatively, the image processing module 202 may determine that the user has a neutral or negative reaction to an image if the user views the image for less than the predetermined threshold value of time, for example, if the user scrolls through a series of images and does not stop or spends less than the threshold value of time viewing a particular image.

In some implementations, the image processing module 202 may receive a set of images associated with a person that does not use the image application. For example, the image processing module 202 may receive images associated with a famous rock star, such as pictures taken by the rock star, promotional pictures of the rock star from different tours, etc. In another example, the image processing module 202 may receive images taken by a photographer. The image processing module 202 may determine that the images are associated with a positive reaction from the person and determine image attributes for the images.

In some implementations, the image processing module 202 may determine a preference for image attributes based on a comparison of images. For example, the image processing module 202 may instruct the user interface module 206 to provide a user with a first image and a second image with a request to select a preferred image from the first image and the second image. The image processing module 202 may select images with a few image attributes to make the comparison easy, such as a first image of a dog and a second image of a cat or a first image of a brightly-colored image and a second image in black and white. The image processing module 202 may receive a selection of either the first image or the second image from the user, and with user consent to use the user's selection, identify the image attributes associated with the selected image that are not associated with the second image, and determine that those image attributes are positive image attributes for the user. The image processing module 202 may provide a user with multiple comparisons, for example, at a time when a user registers or otherwise starts to use the image application 103 in order to develop a user profile for the user that includes preferences for image attributes. In some implementations, the image processing module 202 provides the user with the series of comparisons until the image processing module 202 identifies a threshold number of preferred image attributes for the user. In some implementations, the image processing module 202 periodically provides the user with comparisons to determine if the user's preferences have changed and/or to further refine the image attributes associated with the user.

The metric module 204 may be operable to generate a metric for a first user that reflects preferences for image attributes. In some implementations, the metric module 204 may be a set of instructions executable by the processor 235 to generate the metric. In some implementations, the metric module 204 may be stored in the memory 237 of the computing device 200 and can be accessible and executable by the processor 235.

The metric module 204 may receive a set of images, image attributes for each of the images, and a user's reaction to each of the images from the image processing module 202. In some implementations, the metric module 204 may retrieve the set of images, image attributes for each of the images, and the user's reaction from storage, such as from the storage device 247. For example, the metric module 204 may receive with an image of a child associated with a user; subject to the user's consent, an identification of the child as the user's daughter and metadata associated with the image; and subject to the user's consent, an indication of approval provided by the user.

The metric module 204 may generate the metric by determining which image attributes a user prefers (e.g., which image attributes are associated with a positive reaction by the user), which image attributes the user does not prefer (e.g., which image attributes are associated with a negative reaction by the user), and which image attributes the user has no preference for (e.g., which image attributes are associated with a neutral reaction by the user).

In some implementations, the metric is a multidimensional vector, where each dimension is an image attribute and the metric includes a value for the first user for the attribute (e.g., black and white value is 1, tree value is 0, dog value is 0.5, mountain value is 0.7, etc. In some implementations, the metric is a set of key-value pairs, with an image attribute being the key and the user's preferences being a value. In some implementations, the metric is a matrix with image attributes as one dimension and values as the other dimension.

In some implementations, the metric module 204 may generate a metric score for each image in a set of images based on applying the metric to each image. The metric score may reflect a likelihood of how much a user is expected to like an image. The metric module 204 may also weight different image attributes. For example, a user may have a strongly positive reaction to images of the user's family members and a mildly negative reaction to images of sports cars. The metric module 204 may rank the set of images based on the metric scores associated with the images. For example, the metric module 204 may rank an image as first based on the image including people that the user likes, the image being in focus, and the user providing comments on the image that are associated with a positive sentiment.

In some implementations, when the user consents to the use of user data, the metric module assigns the metric score based on use profile information associated with a user. For example, upon user consent, the metric module 204 maintains a user profile that includes objects that the user has explicitly indicated are positive objects for the user. In some implementations, the user profile may include the user reaction to image attributes determined by the image processing module 202.

In some implementations, the metric module 204 updates the metric score based on new information. For example, the metric module 204 may receive updates about image attributes that the user prefers based on comparisons provided to the user and selections received from the user. In some implementations, the metric module 204 may receive user feedback based on a set of images provided to the user. For example, the user may indicate that the user dislikes some of the images in the set of images or prefers certain images in the set of images over certain other images in the set of images. In another example, the user may view a full collection that a subset of images was selected from, and indicate approval of, some of the images that were not selected. As a result, the metric module 204 may modify the metric accordingly, such as by revising the metric upwards for images that were selected and downwards for images that were not selected.

The metric module 204 receives a set of images and selects a subset of the set of images based on the metric. In some implementations, the metric module 204 may select the subset of the set of images and provide the subset to a first user where the set of images are associated with a second user. For example, the first user may view images associated with a second user and select an option to view personalized images. In this example, the personalized images may include a subset of images that the first user might like from the set of images, e.g., determined based on the first user's preferences for image attributes. This may be advantageous when users publish large collections of images to present other users with a subset of the large collections that they are likely to enjoy, as determined by the metric module 204.

In some implementations, the metric module 204 may select the subset of the set of images and provide the subset to a first user where the metric is based on preferences for image attributes associated with a person that does not use the image application 103. For example, a metric may be generated for the famous photographer Ansel Adams and applied to a user's images so that the user can learn which of the images are in the style of Ansel Adams. In some implementations, the metric module 204 may instruct the user interface module 206 to provide the subset of images with an automated critique based on the metric. The metric module 204 may identify differences between the person's preferences for image attributes and the set of images, and generate the critique based on the differences.

The critique may be serious, such as critiquing the composition of an image or funny, such as a critique based on a famous wildlife photographer stating that the user should have more pictures of monkeys. The critique may be a textual comment, such as “Ansel Adams would love this!” “This looks just like an Ansel Adams photo!” or “Ansel Adams never took pictures that were this blurry!” The critique may include an indication of quality, such as ranked 5 on an Ansel Adams scale. The critique may include a graphical indicator, such as a [symbol] or [symbol] for the image.

In some implementations, the metric module 204 may select images for the subset of images based on the images being associated with metric scores that meet or exceeds a threshold metric value. In some implementations, the metric module 204 selects a percentage of the images for the subset, such as 10%, 15%, etc. In some implementations, the metric module 204 determines an average number of images that a particular user or users in general view in a collection at a given time before moving onto another activity. In these implementations, the metric module 204 selects the subset by ranking the images based on the metric score and selecting a number of images that correspond to the average number of images. In some implementations, the metric module 204 sorts images based on metric scores, and provides the images to a viewer in the sorted order, e.g., from a highest metric score to successively lower metric scores. In these implementations, the subset of images may correspond to the images that the particular user views from the images.

The user interface module 206 may be operable to provide information to a user. In some implementations, the user interface module 206 may include a set of instructions executable by the processor 235 to provide the functionality described below for providing information to a user. In some implementations, the user interface module 206 can be stored in the memory 237 of the computing device 200 and can be accessible and executable by the processor 235.

The user interface module 206 may receive instructions from the other modules in the image application 103 to generate graphical data operable to display a user interface. For example, the user interface module 206 may generate a user interface that displays a set of images and an option to display a subset of the set that are personalized. Responsive to a user selecting the option, the user interface module 206 may generate graphical data operable to display the subset in a new window or display the subset in the same window, such as by expanding the collection to include the images in the subset.

The user interface module 206 may generate an option to apply the metric to a collection of images. In some implementations, the user interface module 206 may provide a way to generate the subset based on a person's preferences. For example, the user interface module 206 may generate a drop-down box with a list of people, a text box where a user may enter names of people, an option to select people from different groups, such as a group of people that the user has categorized as including friends or photographers.

In some implementations, the option to apply the metric may be portable. For example, a first user may be viewing a second user's images where the second user created a subset based on preferences associated with a famous painter. The subset may be displayed with an icon that, when selected causes the user interface module 206 to generate a subset of the first user's images based on the preferences associated with the famous painter.

In some implementations, the user interface module 206 may generate a subset of images where some or all of the images are embedded with links to the original images that were originally hosted on another website or application, such as a social network, a photo sharing website, a messaging application, a chat service, a media sharing website, etc. Once a user clicks the link, the user may be able to view the information associated with the original images, such as comments associated with each of the original images.

In some implementations, the user interface module 206 generates an option that, when selected, causes a backdrop to be generated from a subset of images, a photo book to be generated, or the subset of images to be aggregated to form a collage. The backdrop may include, for example, a series of images that are displayed with transitions between the images, such as a fade from one image to the next image or black frames inserted between images. The photo book may be an electronic photo book or the user interface module 206 may provide information for the user to order a print copy of the images. In some implementations, the user interface module 206 causes the user interface to redirect the user to a third-party web site where the user may order the print copy of the images. In some implementations, the user interface module 206 generates an option to provide the subset as a summary of images that a first user has not previously viewed (e.g., a here's what you missed option). The collage may be an electronic file that the user may set as a background image on a user device.

### Example User Interfaces

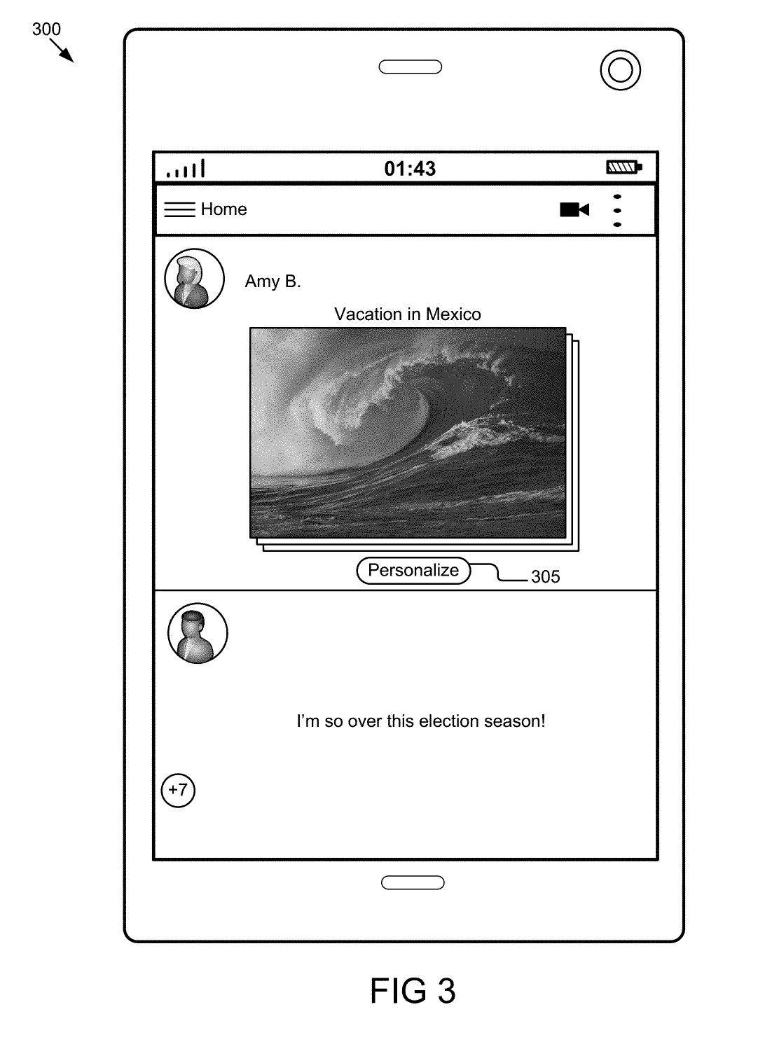

Turning now to FIG. 3, a graphic representation 300 of an example option to personalize another user's images is illustrated according to some implementations. In this example, the user interface module 206 generates a user interface of a user's stream of content on a social network. The stream of content includes vacation photos from user Amy B., who is associated with the user, e.g., on the social network. The user interface module 206 generates a personalize icon 305 that, when selected, causes the image application 103 to generate a subset of the vacation photos from the user Amy B. that reflect the user's preferences for image attributes.

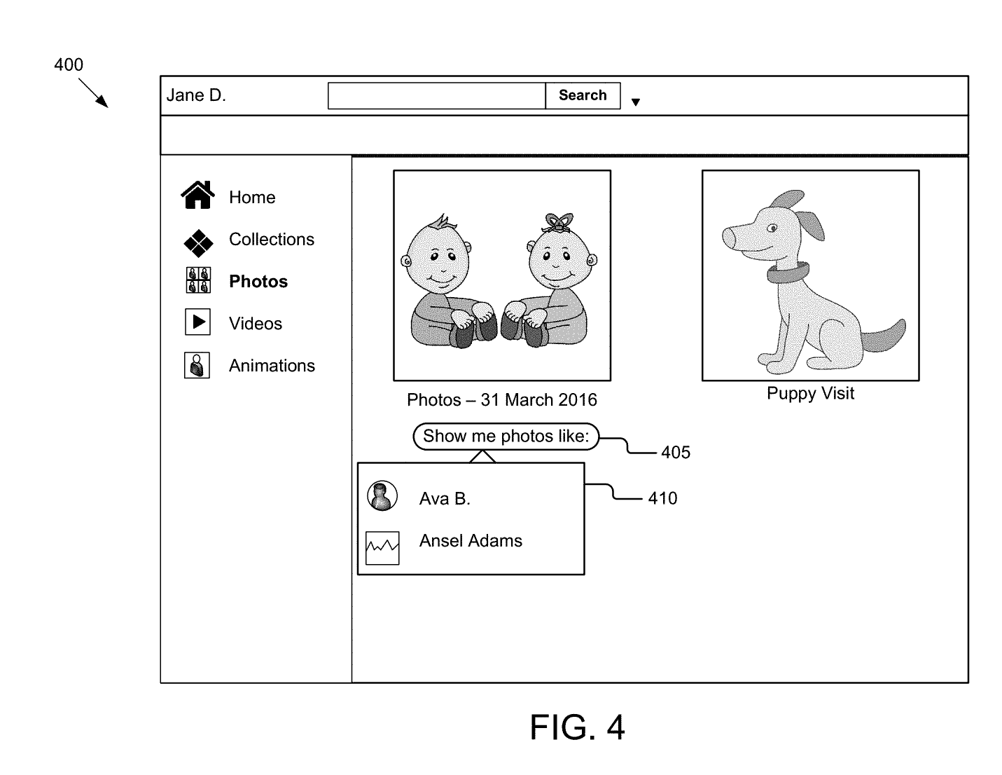

FIG. 4 illustrates a graphic representation 400 of an example option to personalize a user's images according to some implementations. In this example, a user may select an icon 405 that generates a subset of images that would be preferred by another person. The user interface module 206 generates graphical data to display a drop down box 410 that includes different ways to personalize the images. The user Jane D. may select Ava B., who may be connected with the user in a social network, and the photographer Ansel Adams. Responsive to the user Jane D. selecting Ava B. or Ansel Adams from the drop-down box, the user interface module 206 may provide Jane D. with the subset of images that Ava B. or Ansel Adams would prefer from the collection of photos from Mar. 31, 2016.

### Example Method

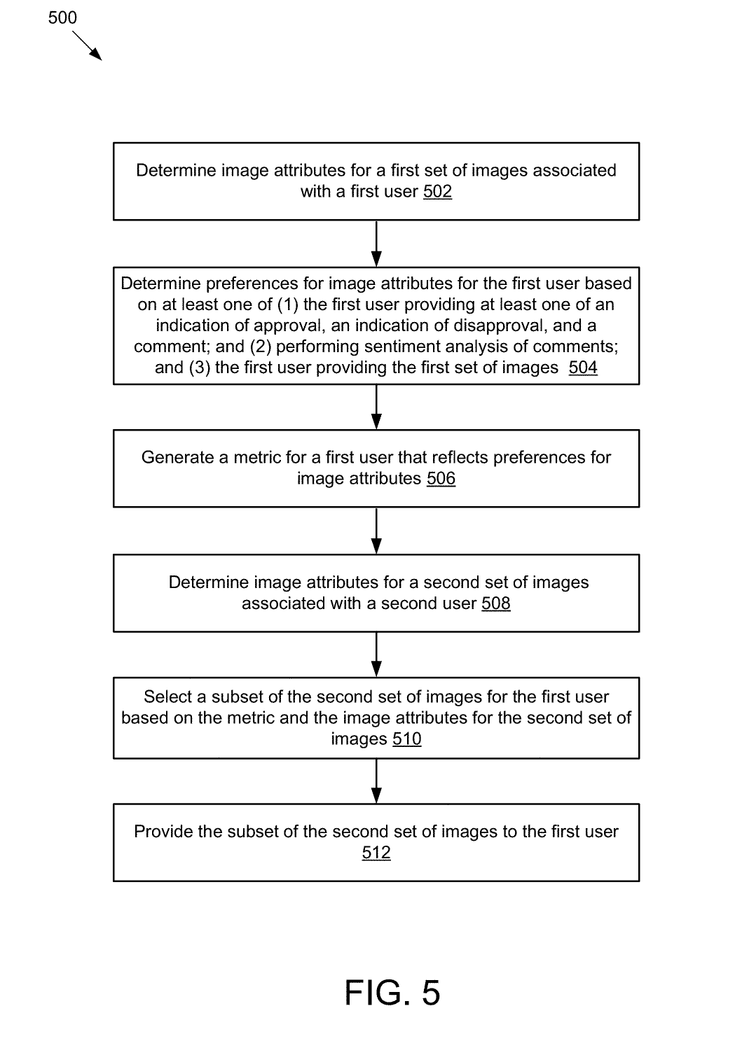

FIG. 5 illustrates a flowchart of an example method 500 to generate personalized images according to some implementations. In some implementations, the steps in FIG. 5 may be performed by the image application 103 of FIG. 1 and/or FIG. 2.

At block 502, image attributes are determined for a first set of images. For example, determining image attributes may include at least one of performing object recognition to identify one or more objects in the second set of images, performing optical character recognition to identify text in the image, performing object recognition to identify one or more people in the second set of images; and performing style recognition to identify one or more styles in the second set of images.

At block 504, preferences for image attributes for the first user are determined based on at least one of (1) the first user providing at least one of an indication of approval, an indication of disapproval, and a comment; (2) performing sentiment analysis of comments; and (3) the first user providing the first set of images. For example, the first may have a preference for images of dogs if the first user provides positive comments on images of dogs.

At block 506, a metric is generated for a first user that reflects preferences for image attributes. For example, the metric may include a metric score for different image attributes based on preferences for image attributes. At block 508, a second set of images is received associated with a second user. At block 510, a subset of the second set of images is selected based on the metric and the image attributes for the second set of images. At block 512, the subset of the second of images is provided to the first user.

While blocks 502 to 512 are illustrated in a particular order, other orders are possible with intervening steps. In some implementations, some blocks may be added, skipped, or combined.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the implementations can be described above primarily with reference to user interfaces and particular hardware. However, the implementations can apply to any type of computing device that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The implementations of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including floppy disks, optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations or some implementations containing both hardware and software elements. In some implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

In situations in which the systems discussed above collect or use personal information, the systems provide users with an opportunity to control whether programs or features collect user information (e.g., information about a user's social network, social actions or activities, profession, a user's preferences, or a user's current location), or control whether and/or how to receive content from the server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server.

What is claimed is:

1. A computer method to generate a personalized image collection, the method comprising:
generating a metric for a first user that reflects preferences for image attributes;
determining image attributes for a first set of images associated with a second user;
selecting a subset of the first set of images for the first user based on the metric and the image attributes for the first set of images; and
providing the subset of the first set of images to the first user.

2. The method of claim 1, wherein selecting the subset of the first set of images is based on an identification of images of the first set of images where the first user provided at least one of an indication of approval and a comment.

3. The method of claim 1, wherein generating the metric comprises:
identifying a second set of images for which the first user provided a comment on each image in the second set of images;
performing sentiment analysis on a respective comment associated with each image, wherein the respective comment includes at least one of a positive reaction, a neutral reaction, and a negative reaction; and
determining, based on the sentiment analysis, image attributes for each image of the second set of images.

4. The method of claim 1, wherein generating the metric comprises:
identifying a second set of images that the first user provided;
determining image attributes associated with the second set of images; and
determining the preferences for the image attributes associated with the second set of images as being positive to the first user based on the first user providing the second set of images.

5. The method of claim 4, wherein determining image attributes associated with the second set of images includes at least one of performing object recognition to identify one or more objects in the second set of images, performing optical character recognition to identify text in the second set of images, performing object recognition to identify one or more people in the second set of images; and performing style recognition to identify one or more styles in the second set of images.

6. The method of claim 1, wherein selecting the subset of the first set of images for the first user based on the metric and the image attributes for the first set of images includes:
for each image of the first set of images, computing a metric score based on the metric and the image attributes;
comparing each metric score to a threshold score value; and
selecting the subset to include images from the first set of images with corresponding metric scores that meet the threshold score value.

7. The method of claim 1, further comprising:
providing the first user with an option to causes a backdrop to be generated from a subset of images, a photo book to be generated, or the subset of images to be aggregated to form a collage.

8. The method of claim 1, further comprising:
providing the second user with the subset of the first set of images, wherein a first image of the subset of the first set of images includes a link that, when selected, causes a display of a comment associated with the first image.

9. The method of claim 1, wherein generating the metric for the first user that includes the preferences for image attributes comprises:
providing to the first user a first image and a second image with a request to select a preferred image from the first image and the second image;
receiving a selection of the first image from the first user; and
identifying the image attributes associated with the first image that are not associated with the second image.

10. A non-transitory computer storage medium encoded with a computer program, the computer program comprising instructions that, when executed by one or more processors, cause the one or more processors to perform operations comprising:
generating a metric for a first person that reflects preferences for image attributes;
determining image attributes for a first set of images associated with a second user;
selecting a subset of the first set of images for the second user based on the metric and the image attributes for the first set of images; and
providing the subset of the first set of images to the second user.

11. The computer storage medium of claim 10, wherein the operations further comprise:
identifying a second set of images that are associated with the first person;
determining image attributes associated with the second set of images; and
determining the preferences for the image attributes associated with the second set of images.

12. The computer storage medium of claim 11, wherein determining image attributes associated with the second set of images includes at least one of performing object recognition to identify one or more objects in the second set of images, performing optical character recognition to identify text in the second set of images, performing object recognition to identify one or more people in the second set of images; and performing style recognition to identify one or more styles in the second set of images.

13. The computer storage medium of claim 10, wherein the operations further comprise:
providing the second user with an option to apply the metric for the first person to the first set of images associated with the second user and to provide an automated critique of the second set of images based on the metric.

14. The computer storage medium of claim 10, wherein selecting the subset of the first set of images is based on an identification of images of the first set of images where the second user provided at least one of an indication of approval and a comment.

15. A computer system comprising:
one or more processors coupled to a memory;
a metric module stored in the memory and executable by the one or more processors, the metric module operable to generate a metric for a first user that reflects preferences for image attributes; and
an image processing module stored in the memory and executable by the one or more processors, the image processing module configured to determine image attributes for a first set of images associated with a second user;
wherein the metric module selects a subset of the first set of images for the first user based on the metric and the image attributes for the first set of images and provides the subset of the first set of images to the first user.

16. The system of claim 15, wherein selecting the subset of the first set of images is based on an identification of images of the first set of images where the first user provided at least one of an indication of approval and a comment.

17. The system of claim 15, wherein generating the metric comprises:
identifying a second set of images for which the first user provided a comment on each image in the second set of images;
performing sentiment analysis on a respective comment associated with each image, wherein the respective comment includes at least one of a positive reaction, a neutral reaction, and a negative reaction; and
determining, based on the sentiment analysis, image attributes for each image of the second set of images.

18. The system of claim 15, wherein generating the metric comprises:
identifying a second set of images that the first user provided;
determining image attributes associated with the second set of images; and
determining the preferences for the image attributes associated with the second set of images as being positive to the first user based on the first user providing the second set of images.

19. The system of claim 18, wherein determining image attributes associated with the second set of images includes at least one of performing object recognition to identify one or more objects in the second set of images, performing optical character recognition to identify text in the second set of images, performing object recognition to identify one or more people in the second set of images; and performing style recognition to identify one or more styles in the second set of images.

20. The system of claim 15, wherein selecting the subset of the first set of images for the first user based on the metric and the image attributes for the first set of images includes:
for each image of the first set of images, computing a metric score based on the metric and the image attributes;
comparing each metric score to a threshold score value; and
selecting the subset to include images from the first set of images with corresponding metric scores that meet the threshold score value.
